(19) United States
(12) Patent Application Publication
(10) Pub. No.: US 2007/0157132 A1
(43) Pub. Date: Jul. 5, 2007

(54) Process of automatically translating a high level programming language into a hardware description language

(75) Inventors: Fu-Chiung Cheng, Taipei City (TW); Jian-Yi Chen, Taipei City (TW); Kuan-Yu Yan, Taipei City (TW); Shin-Hway Yu, Taipei City (TW); Kuan-Yu Chen, Taipei City (TW); Chieh-Ju Wang, Taipei City (TW); Shu-Ming Chang, Taipei City (TW); Ping-Yun Wang, Taipei City (TW); Li-Kai Chang, Taipei City (TW); Chin-Tai Chou, Taipei City (TW); Chi-Huam Shieh, Taipei City (TW); Ming-Shiou Chiang, Taipei City (TW); Nian-Zhi Huang, Taipei City (TW); Hung-Chi Wu, Taipei City (TW)

Correspondence Address: BACON & THOMAS, PLLC, 625 SLATERS LANE, FOURTH FLOOR, ALEXANDRIA, VA, 22314, US

(73) Assignee: Tatung Company, Taipei City (TW)

(21) Appl. No.: 11/472,365

(22) Filed: Jun. 22, 2006

(30) Foreign Application Priority Data
Dec. 30, 2005 (TW) 094147596

(51) Int. Cl. G06F 17/50; G06F 9/45

(52) U.S. Cl. 716/3; 717/136

(57) ABSTRACT

A process of automatically translating a high level programming language into a hardware description language (HDL), which can use a three-stage translation mechanism to generate the HDL codes corresponding to the functions described by the high level programming language. The first stage translates source codes coded by the high level programming language into an extended activity diagram (EAD). The second stage translates the EAD into a hardware component graph (HCG). The third stage generates the respective signal connections of HDL components according to all edges of the HCG, and outputs an HDL entity and architecture to a file in a string form, thereby completing the entire translation.

### BACKGROUND OF THE INVENTION

1. Field of the Invention

The invention relates to a process of automatically translating a high level programming language into a hardware description language (HDL) and, more particularly, to a three-stage translation process of automatically translating a high level programming language into an HDL, which translates the high level programming language into an extended activity diagram (EAD), then the EAD into a hardware component graph (HCG), and the HCG into the HDL.

2. Description of Related Art

Typically high level programming languages, such as Java, C, C++, etc., cannot translate the functions of source codes directly into corresponding hardware description languages (HDL) such as VHDL. This is because the typical HDL is not suitable for a direct description to the programming logic and executing flow of a high-level programming language. Accordingly, it causes a trouble in design. In addition, due to the various high-level programming languages and associated features, the designed programs cannot be unified and thus obtained a complete executing flow; even they have a same function, which causes a trouble in hardware design.

Therefore, it is desirable to provide an improved process to mitigate and/or obviate the aforementioned problems.

### SUMMARY OF THE INVENTION

The object of the invention is to provide a process of automatically translating a high level programming language into a hardware description language (HDL). The process includes: (A) reading source codes coded by the high level programming language; (B) translating the source codes into an extended activity diagram (EAD); (C) translating the EAD into a hardware component graph (HCG); (D) translating the HCG into the HDL; and (E) outputting the HDL.

In the process of automatically translating a high level programming language into a hardware description language (HDL), the high level programming language can be a known high level programming language, and preferably a Java, C, or C++ language.

In the process of automatically translating a high level programming language into a hardware description language (HDL), the HDL can be a known HDL, and preferably a VHDL.

In the process of automatically translating a high level programming language into a hardware description language (HDL), the EAD is a flow control graph.

In the process of automatically translating a high level programming language into a hardware description language (HDL), the HCG represents a connection relation between hardware components.

Other objects, advantages, and novel features of the invention will become more apparent from the following detailed description when taken in conjunction with the accompanying drawings.

### BRIEF DESCRIPTION OF THE DRAWINGS

FIG. 1 is a flowchart of a three-stage translation process of automatically translating a high level programming language into an HDL according to a preferred embodiment of the invention;

FIG. 2 is an activity diagram defined in a UML language according to a preferred embodiment of the invention;

FIG. 3 is a flowchart of modifying an activity diagram into an extended activity diagram according to a preferred embodiment of the invention;

FIG. 4 is a flowchart of an implementation of translating source codes into an EAD according to a preferred embodiment of the invention;

FIG. 5 is a flowchart of a complete translation process of translating source codes into an EAD according to a preferred embodiment of the invention;

FIG. 6A is a graph of a Java program according to a preferred embodiment of the invention;

FIG. 6B is a graph of an EAD of the Java program of FIG. 6A according to a preferred embodiment of the invention;

FIG. 7A is a graph of a start node of a preferred embodiment of the invention;

FIG. 7B is a graph of an end node of a preferred embodiment of the invention;

FIG. 7C is a graph of component nodes of a preferred embodiment of the invention;

FIG. 7D is a graph of control path nodes of a preferred embodiment of the invention;

FIG. 7E is a graph of data path nodes of a preferred embodiment of

FIG. 8 is a flowchart of a process of translating an EAD into an HCG according to a preferred embodiment of the invention;

FIG. 9 is a graph of an HCG corresponding to an EAD according to a preferred embodiment of the invention;

FIG. 10 is a graph of a process of translating an HCG into a VHDL according to a preferred embodiment of the invention;

FIG. 11 is a schematic graph of a Java adder according to a preferred embodiment of the invention;

FIG. 12 is a schematic graph of an HCG corresponding to the Java adder of FIG. 11 according to a preferred embodiment of the invention;

FIGS. 13 to 17 are schematic graphs of an HCG modifying process according to a preferred embodiment of the invention; and

FIGS. 18 to 25 are schematic graphs of translating an HCG into VHDL codes according to a preferred embodiment of the invention.

### DETAILED DESCRIPTION OF THE PREFERRED EMBODIMENT

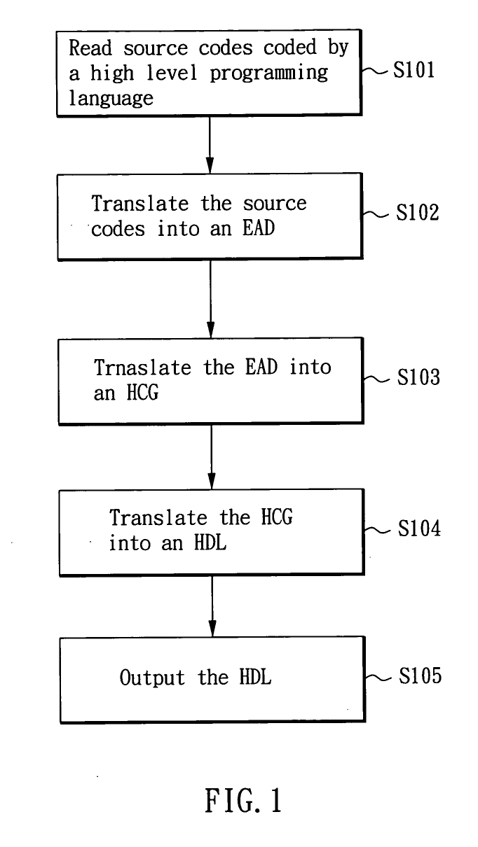

The invention provides a three-stage translation process since the typical process cannot translate a high level programming language into a hardware description language (HDL) directly. FIG. 1 shows a three-stage translation process. In FIG. 1, a function described by a high level programming language, such as Java, C, C++, can be translated into a VHDL through three stages. The first stage translates the corresponding source codes into an EAD (source code→EAD), the second stage translates the EAD into an HCG (EAD→HCG), and the third stage translates the HCG into the VHDL (HCG→VHDL). As shown in FIG. 1, in the first stage (source code→EAD), step S101 reads source codes coded by a high level programming language, and step S102 translates the source codes read into an EAD. In the second stage (EAD→HCG), step S103 translates the EAD into an HCG In the third stage, step S104 generates a corresponding VHDL (including signal connections of VHDL components) according to the edges of the HCG, and step S105 outputs the VHDL entity and architecture to a file in a string form, thereby generating the corresponding HDL (e.g., the VHDL codes).

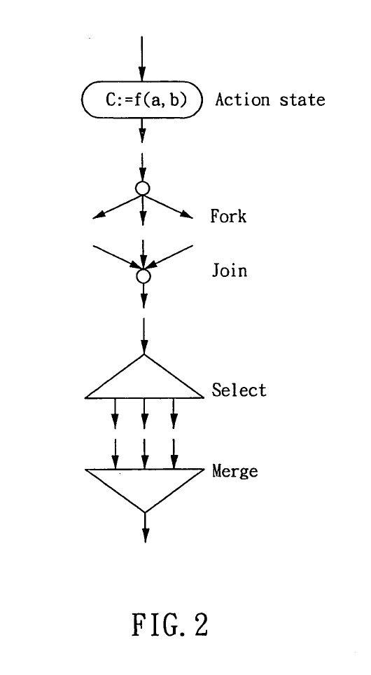

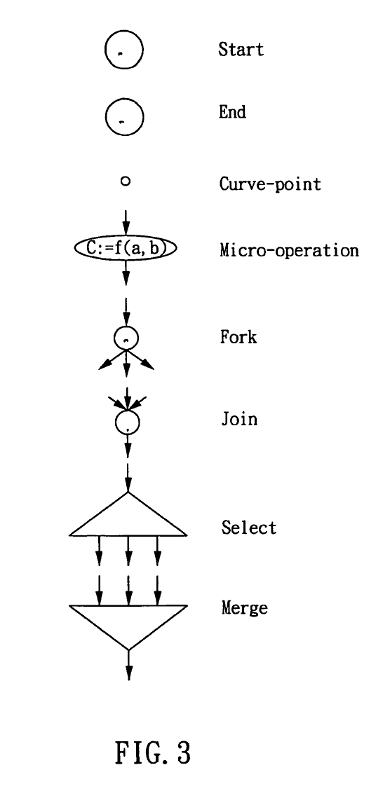

As cited in the first stage, the source codes are first translated into a temporal format called activity diagram (AD), which is a flow description graph, as shown in FIG. 2, defined in a unified modeling language and including five elements: action state, fork, join, select and merge. In this embodiment, some elements are modified in order to reserve the information required for certain programs, and the modified activity diagram is referred to as an extended activity diagram (EAD). FIG. 3 is a flowchart of modifying an activity diagram into an extended activity diagram.

As shown in FIG. 3, the EAD is a corresponding flow control graph translated from the source codes of a high level programming language, which consists of nodes that can be divided into multiple subgraphs with different node combinations, each subgraph having start, operation and end parts. In this embodiment, the nodes are defined as follows.

1. A start node indicates the start of a subgraph.

2. An end node indicates the end of a subgraph.

3. A curve point node indicates two directional edges for providing a convenience in a translation process, which have no practical affection on an operation.

4. A micro-operation node indicates a statement or expression processing.

5. A fork node indicates a parallel operation.

6. A join node indicates that an output signal is sent only when the outputs of all micro-operations are collected.

7. A select node indicates to select an appropriate output signal after decoding.

8. A merge node indicates to merge all input signals into an output signal to output.

Each node is regarded as an object in which two types of data are recorded to indicate an input node connected to the node and an output node connecting from the node to another node, and the node type is changed with the syntax. A corresponding subgraph is generated with each syntax segment analysis, and the input nodes and output nodes of the subgraph are recorded for other subgraphs to further link and use. Accordingly, a corresponding subgraph can be generated by such a linking for each syntax segment, and linking all subgraphs can achieve the purpose of translating source codes into a corresponding activity diagram and presenting the programming logic and executing flow of the source codes in a visualization form.

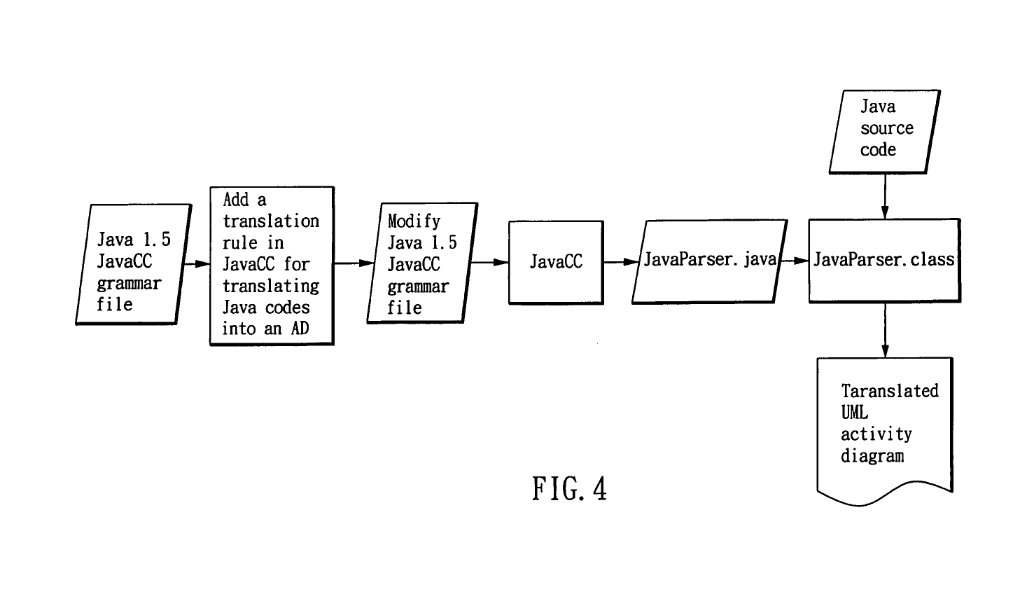

FIG. 4 is a flowchart of translating a high level programming language into an EAD. As shown in FIG. 4, an example is given in a Java language to implement a Java program into an EAD. Upon the Java standard syntax specification (using Java development Kit (JDK) 1.5) defined by Java Complier Compiler (briefly, JavaCC hereinafter), a Java segment is added in a JavaCC grammar file to generate a modified Java syntax file. Thus, the JavaCC can generate a Java parser class and other classes required by the Java parser, according to the Java grammar file with the added segment. The Java parser class can provide the function of translating Java source codes into a corresponding EAD. In this case, the Java parser class is integrated (CAD) software, such that the CAD software is equipped with the translating function. Subsequently, the complete source codes of a Java program are sent to the Java parser. The Java parser can match different tokens in the Java program with new EAD instructions generated in the modified syntax file, and accordingly executes a translation to obtain a desired EAD.

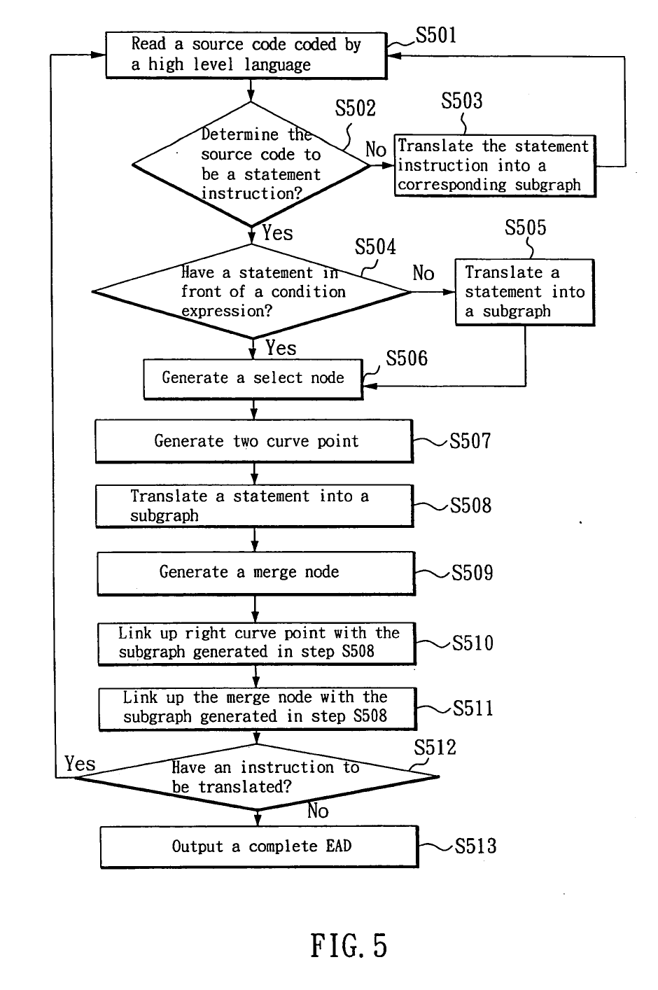

FIG. 5 shows a complete translation process. As shown in FIG. 5, for automatically converting source codes into a corresponding activity diagram, first, a source code of a high level programming language is read (step S501). Next, a type of the source code is determined to be a statement instruction or not. In this case, the statement instruction includes the instructions of for, while, do, if and switch. When the source code is not a statement instruction, i.e., the source code is a non-statement instruction not including the instructions of for, while, do if and switch, the non-statement instruction is translated directly into a corresponding subgraph (step S503), and a next source code is read (step S501).

When the source code is determined to be a statement instruction in step S502, it is further determined if a statement is in front of a condition expression in the statement instruction (step S504); if yes, the statement is translated into a corresponding subgraph (step S505), and subsequently a select node is generated (step S506).

When there is no statement in front of a condition expression in the statement instruction, the select node is generated directly (step S506). Next, left and right curve points are generated (step S507) and respectively linked to the select node. Next, a statement, which is not in front of the condition expression in the statement instruction, is translated into a corresponding subgraph (step S508). Next, a merge node is generated (step S509) to merge the subgraphs. Next, the subgraph generated in step F is respectively linked up with the right curve point (step S510) and the merge node (step S511). At last, it is determined if an instruction is to be translated into a corresponding subgraph (step S512); if yes, step (A) is executed; and if not, a complete extended activity diagram (EAD) is output (step S513).

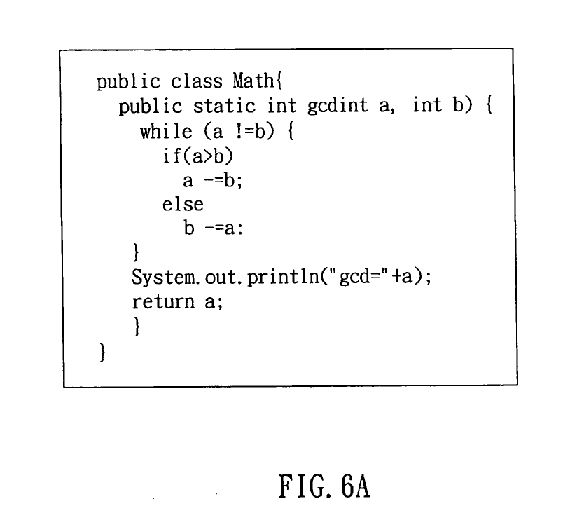

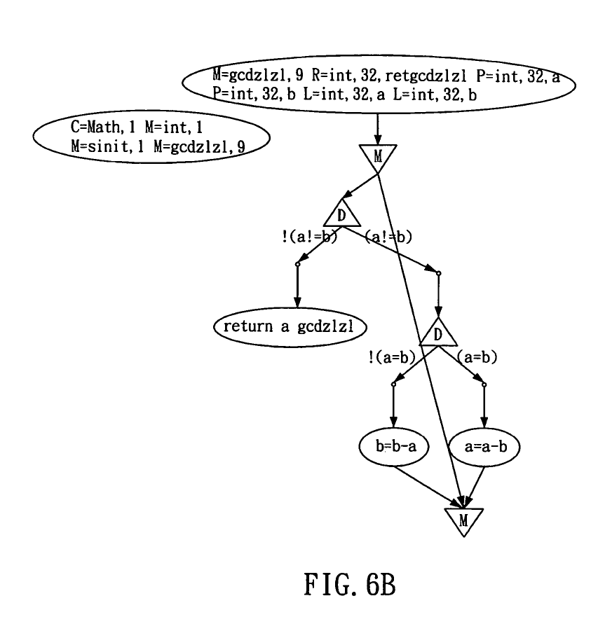

Accordingly, a complete Java program can be translated into a corresponding EAD, and the programming logic and executing flow of the source codes of the high level language is presented in a visualization form. FIG. 6a is a graph of an accumulation program coded with if and while statements of the Java language, which can be translated into a corresponding EAD shown in FIG. 6b, according to the translation flow and rule of the invention. In addition, programs having a same function and coded by different high-level languages can be translated into the respective EADs. An EAD is generated different with different Java grammars.

Thus, the first stage translation is complete. Subsequently, the second stage translation is preceded to translate a complete EAD into a corresponding HCG to thereby represent a relation between a high level programming language and hardware.

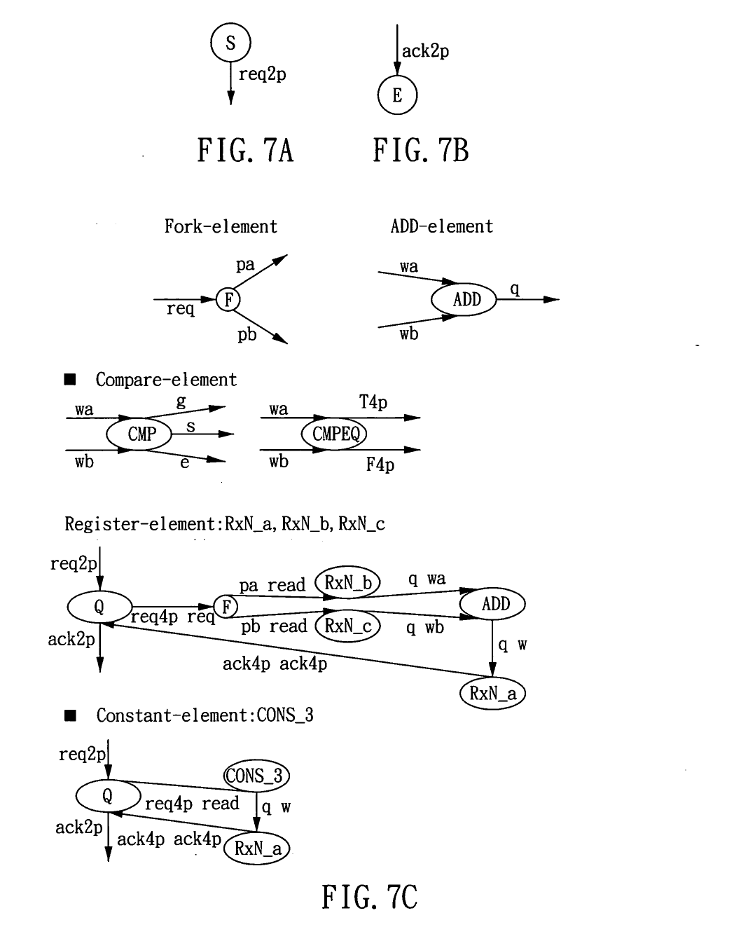

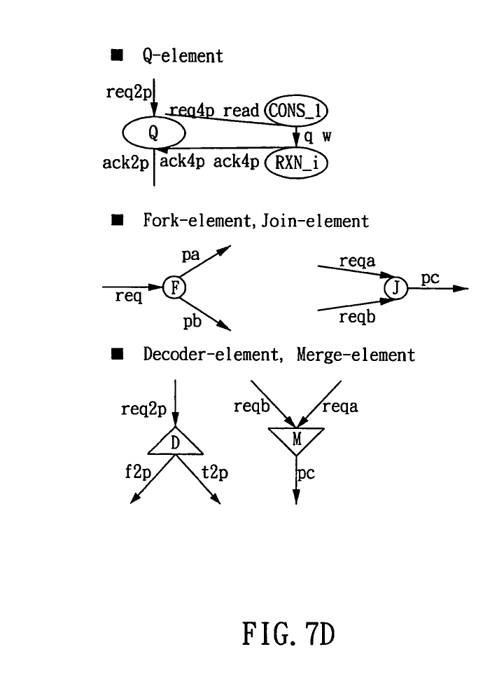

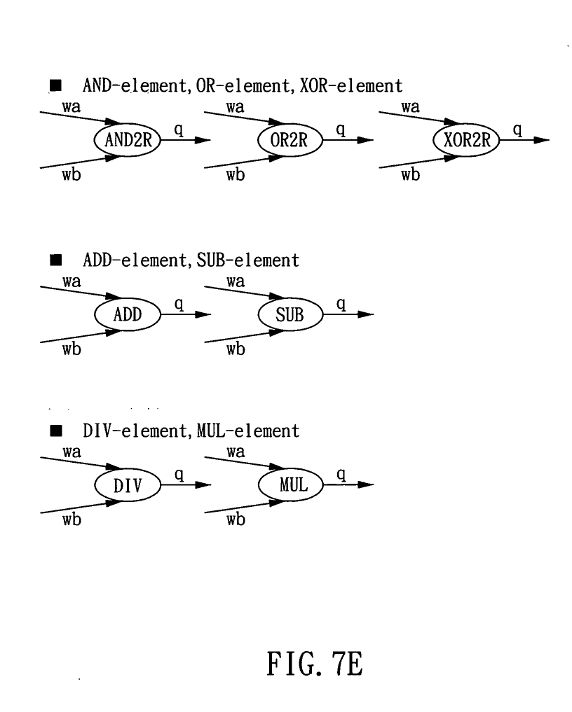

FIGS. 7A to 7C show an HCG specification. An HCG contains three types of nodes, start node, end node and component node.

1. The start node shown in FIG. 7A records the information of class name, method name, parameter, local variable, global variable, return type of a Java program, wherein,
i. the method information contains method name and its modifiers;
ii. the return value information contains return type, bit size and return name;
iii. the parameter information contains parameter type, bit size and parameter name; and
iv. the local variable information contains local variable type, bit size and local variable name.

2. The end node shown in FIG. 7B indicates that a method is ended, and a variable name to be returned is labeled. When the content of the end node contains a keyword “VOID”, it indicated that no variable is returned.

3. The component nodes shown in FIG. 7C are hardware components labeled register, fork, adder and the like. A directional edge links between the nodes, and a label on each directional edge indicates a link from an output port of a source object to an input port of a target object.

The component nodes can be further grouped into two part, control path modules and data path modules.

(1) As shown in FIG. 7D, the control path modules include
a Q-element to indicate that the hardware corresponding to the Q-element requires performing in sequence;
a fork-element to indicate that the hardware corresponding to the fork-element requires performing in parallel;
a join-element to indicate that the hardware corresponding to the join-element sends an output signal only when all associated operations are arrived;
a decoder-element to indicate that the hardware corresponding to the decoder-element selects an appropriate output signal after decoding;
a merge-element to indicate that the hardware corresponding to the merge-element merges input signals to output.

(2) As shown in FIG. 7E, the data path modules include:
arithmetic logic unit (ALU), containing AND-element, OR-element, XOR-element, ADD-element, SUB-element, MUL-element and DIV-element;
register-element, i.e., RxN-element;
multiplexer and demultiplexer, i.e., RMUXDEMUX-element and WMUXDEMUX-element; and
constant, i.e., CONS-element.

In addition, the content of the component node can be represented as follows.

(1) The registers and the constants, which require labels to separate, can be expressed as:
Component name_variable name.

(2) The micro-operation (MICROOP), compare-element (CMP), the merge-element (MERGE) and the like, which do not require labels, can be expressed directly as:
Component name.

In addition, the directional edge between the nodes can be expressed as:
Source node output port→target node input port.

As cited, upon the HCG specification, the EAD can be converted into the corresponding HCG that is more associated with hardware components.

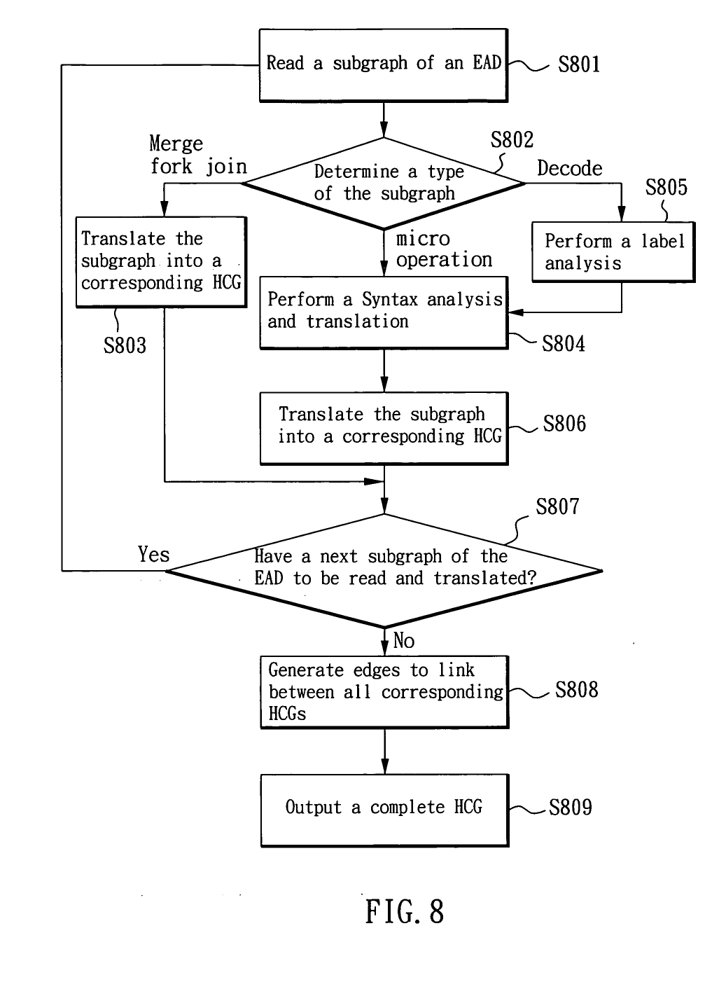

FIG. 8 is a flowchart of a process of translating an EAD into an HCG As shown in FIG. 8, step S801 reads a subgraph of the EAD. Step S802 determines a type on the subgraph of the EAD. When a fork, join or merge type is determined, the subgraph of the EAD is translated directly into a corresponding HCG (step S803), and a next subgraph of the EAD is read and translated into a corresponding HCG repeatedly until all subgraphs of the EAD are complete.

When a micro-operation type is determined in step S802, a syntax analysis and translation (step S804) is performed on the subgraph read, i.e., the micro-operation subgraph, and accordingly the micro-operation subgraph is translated into a corresponding HCG (step S806). Subsequently, a next subgraph of the EAD is read and translated into a corresponding HCG repeatedly until all subgraphs of the EAD are complete.

When a select type is determined in step S802, the labels on the output ports of obtained corresponding HCGs are analyzed (step S805), and a syntax analysis and translation is performed (step S804) on the subgraph read, i.e., the select subgraph. Accordingly, the select subgraph is translated into a corresponding HCG (step S806). Subsequently, a next subgraph of the EAD is read and translated into a corresponding HCG repeatedly until all subgraphs of the EAD are complete (step S807). When all subgraphs of the EAD are complete, edges between input and output ports of all obtained HCGs are generated (step S808) to form a complete HCG, and the complete HCG is output (step S809).

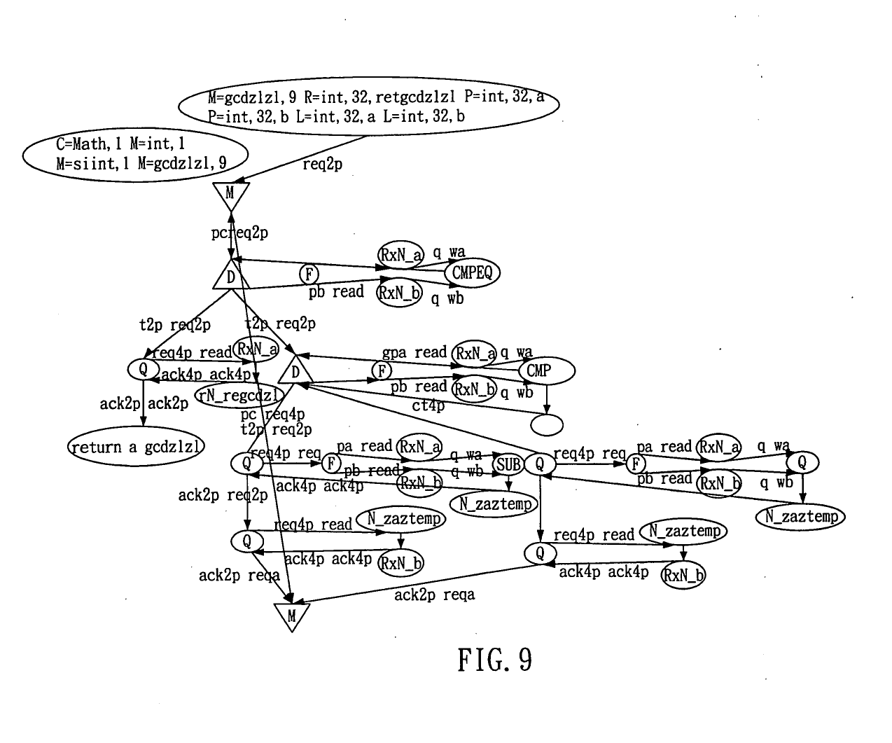

Thus, after the aforementioned steps, a complete EAD can be translated into a corresponding HCG (as shown in FIG. 9) in which the top node is the start node to record class and method information of the Java program, and the bottom node is the end node to indicate the method end and request a return value. The other nodes in FIG. 9 are labeled to represent the hardware components of register, micro-operation, fork and adder respectively, and a directional edge between the nodes labels from an output port of a source object to an input port of a target object.

Thus, the second stage translation is complete. Subsequently, the third stage is preceded to generate corresponding signal connections between Very High Speed Integrated Circuit Hardware Description Language (VHDL) components according to the edges of an HCG and output the VHDL entity and architecture into a file in a string form to thereby complete the entire translation.

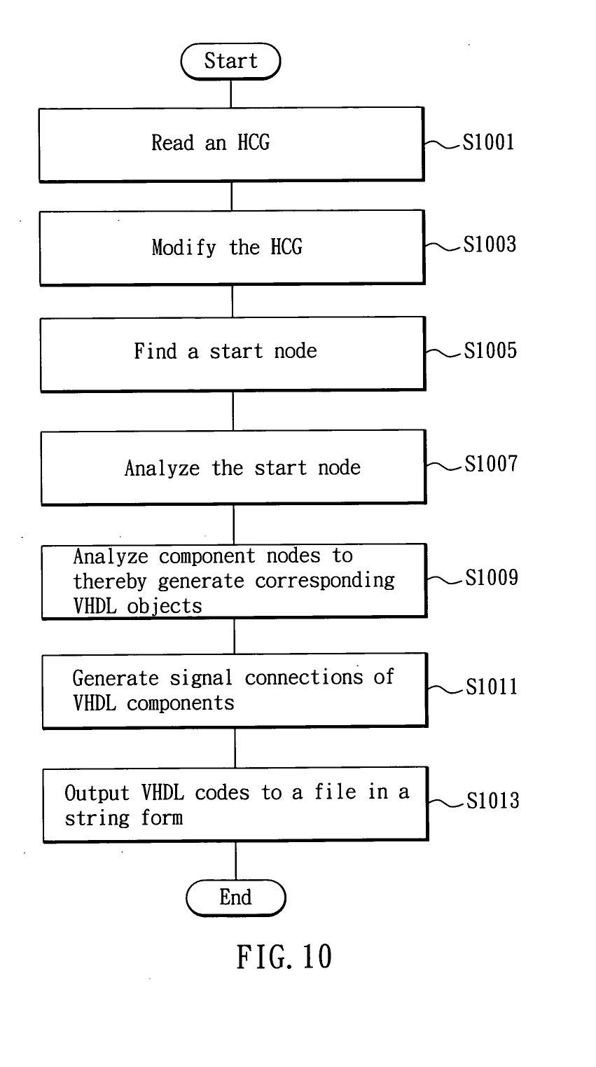

FIG. 10 is a flowchart of a process of translating an HCG into a VHDL. As shown in FIG. 10, step S1001 reads an HCG having multiple hardware component subgraphs. Next, step S1003 modifies the HCG, for the HCG is not associated with physical hardware components and cannot be translated directly into a VHDL language. Thus, the components defined in the modified HCG and the VHDL language can match to each other.

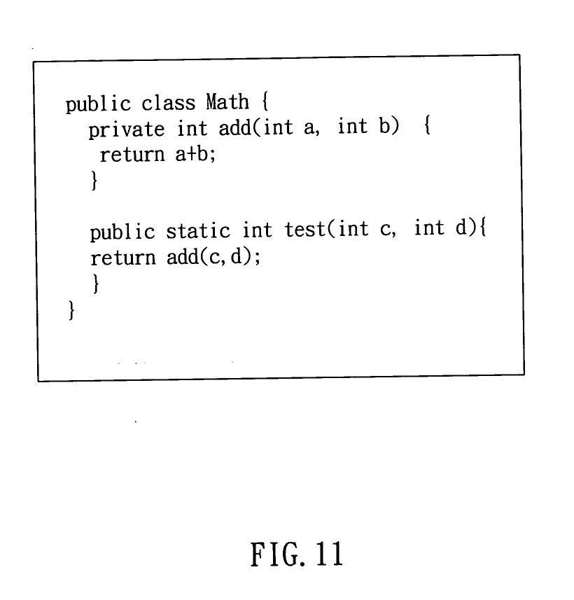

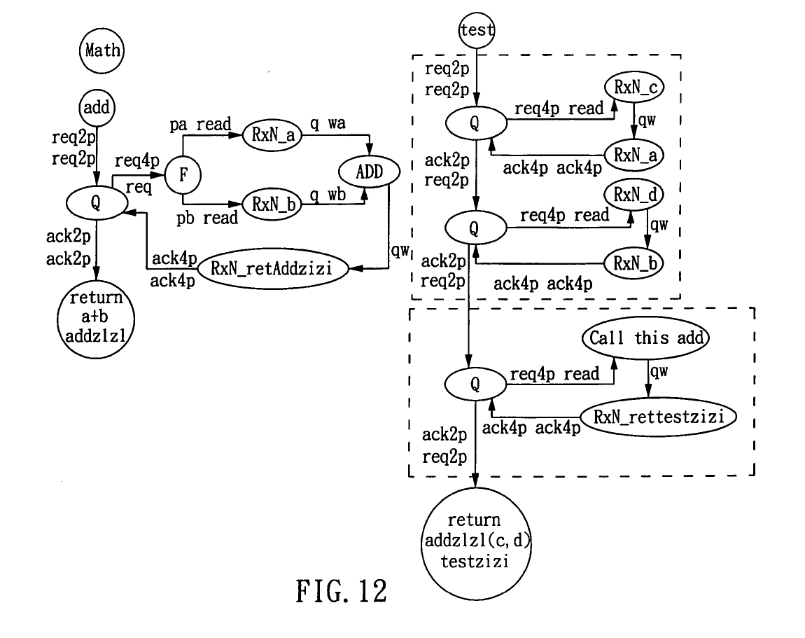

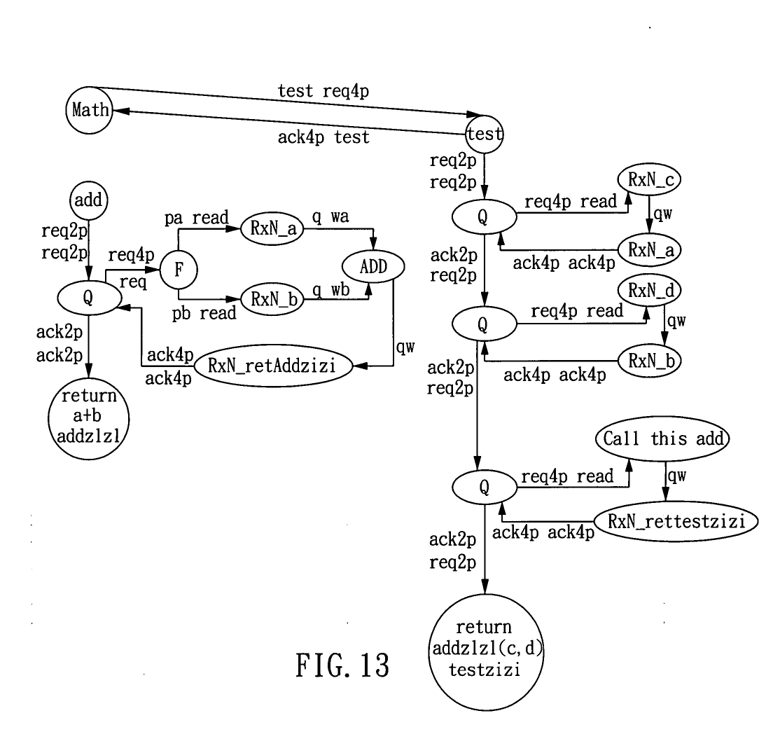

An example is given in the Java adder of FIG. 11 for description, and an HCG corresponding to the Java adder of FIG. 11 is shown in FIG. 12. As shown FIG. 13, when a public method (named “test” in this case) is found according to the class information and the HCG, an edge is formed to connect a method start node (a circle containing “test”) to a class start node (a circle containing “Math”). The edge has a label “method_name req4p”, which represents that the public method has an input signal named “method_nameReq4p” on a corresponding hardware interface and the input signal is connected to a port named “req4p” at the method start node. Similarly, a different edge is formed to connect the class start node to the method start node. The label “ack4p method_name” on the edge represents that a signal line is connected from a port named “ack4p” at the method start node to an output signal named “method_nameAck4p” on the hardware interface.

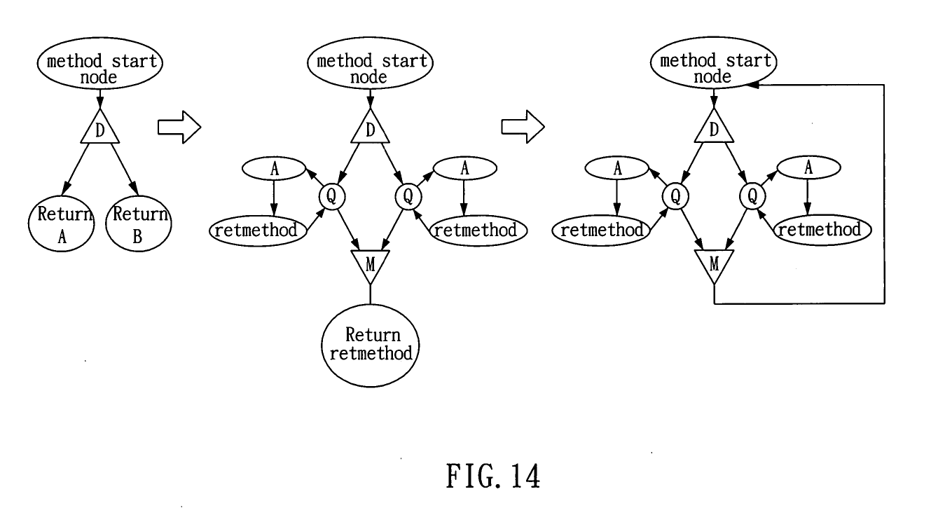

Each return can send a data out and an end signal back to a start node. Accordingly, if a discriminant is found, different return values can be received. To overcome this, as shown in FIG. 14, merging multiple return nodes are required, which first stores all return values to be sent in a register. The register is named “retMethod_name”. Next, using a merge element connects a signal line to an end node labeled “return retMethod_name”. Finally, the end node is eliminated in order to connect the merge node back to the method start node since the end node indicates only a flow end without any meaning in hardware and an acknowledgement is not returned to indicate an execution end in an asynchronous system.

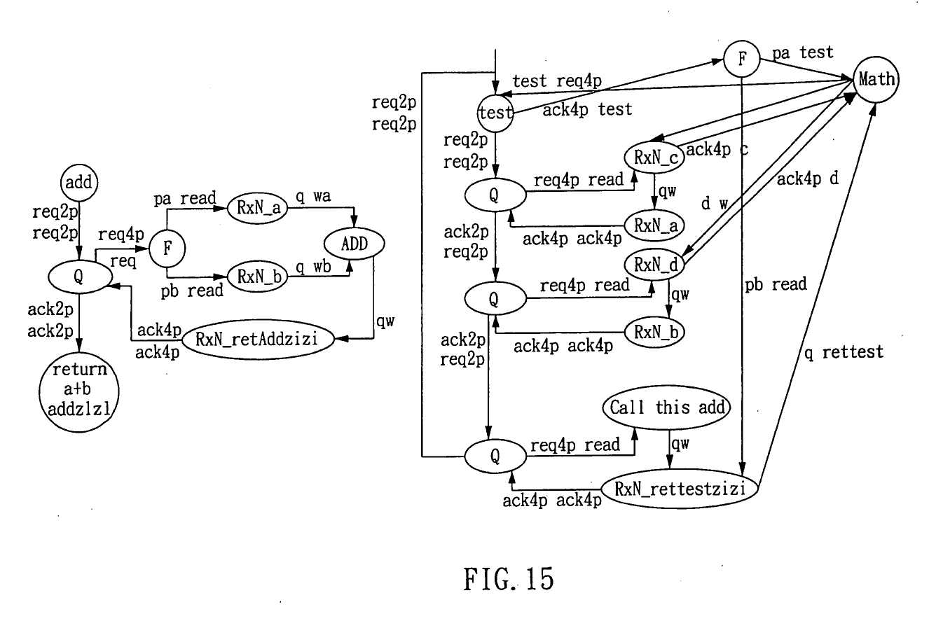

Upon the class information and the HCG, public parameters and return values in the HCG can be found. As shown in FIG. 15, the nodes corresponding to the public parameters and return values found are linked to the class start node, which indicates that the nodes have corresponding hardware interfaces for external signal input and output. For a public parameter, an input signal line labeled “parameter_name w” is connected from the class start node to a register node containing the public parameter, which indicates that data is input from the hardware interface to a register indicated by the register node. In addition, a signal line labeled “ack4p parameter_name” is connected from the register node to the hardware interface, which indicates that an acknowledgement is returned from the register to the hardware interface. For a return value, a signal line is connected from the method start node to a return value register node. Because the port for output is identical to that connected to the class start node, a fork node is used to divide the line connected to the class start node into two, such that one can be connected to the return register node. Also, the return register node uses a line to connect to the class start node for indicating a return value output labeled “q retMethod_name.

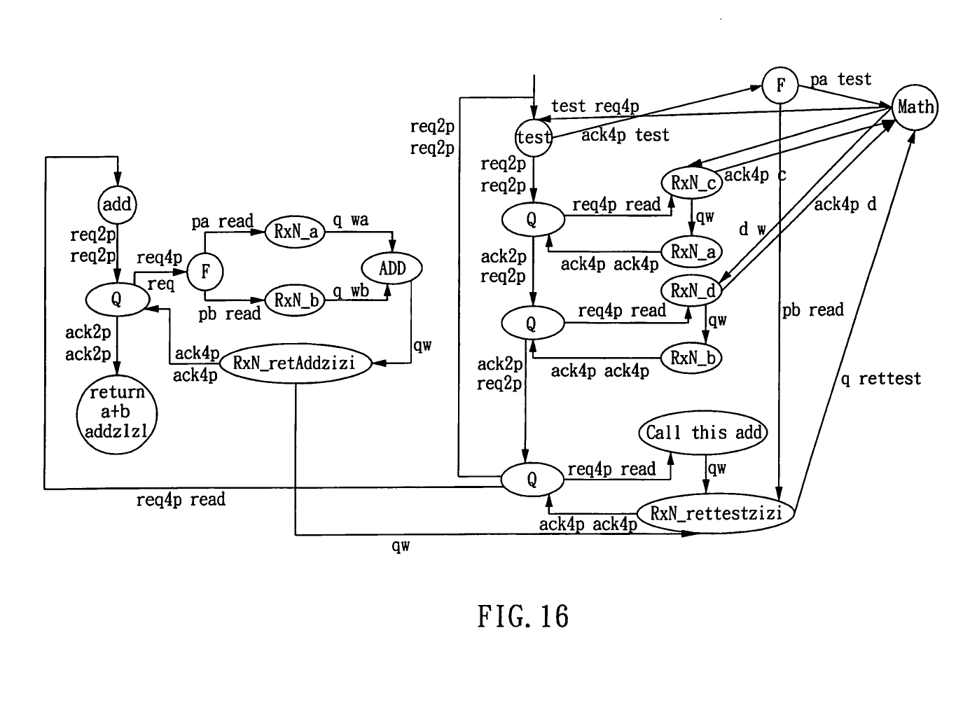

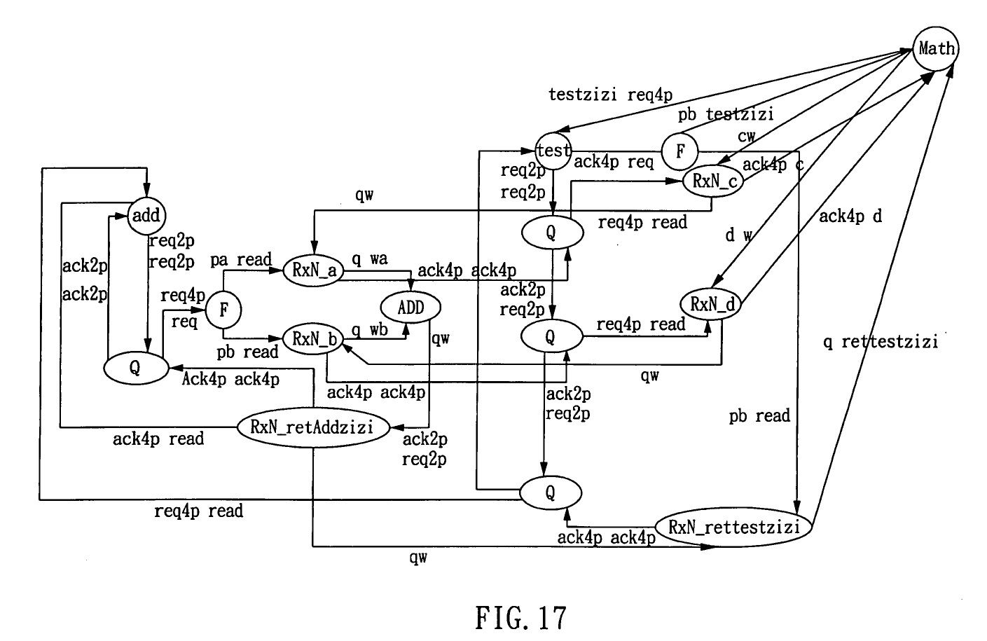

As shown in FIG. 16, the method information is collected from the class information and the input/output edges or lines are collected from the HCG, thereby generating required method call information. The method call information is further used to change the edges in the HCG from the method call node to the method start node to thereby represent the method calls. At processing the edges, one or more multiplexers and demultiplxers are added to control corresponding inputs and outputs. If multiple registers shown in the HCG have a same label, it indicates the multiple registers are the same. In this case, the registers are merged to form a modified HCG shown in FIG. 17.

Referring again to FIG. 10, subsequently, step S1005 finds a start node of the modified HCG to thereby obtain a corresponding hardware component subgraph (briefly, subgraph). The start node found in step S1005 is a method start node. Because the nodes in the modified HCG can be related to the respective VHDL objects, a translation to the VHDL objects can start with the method start node.

Step S1007 analyzes the information of the method start node to thereby add input and output components and generate a VHDL entity, and repeats until all start nodes are analyzed completely.

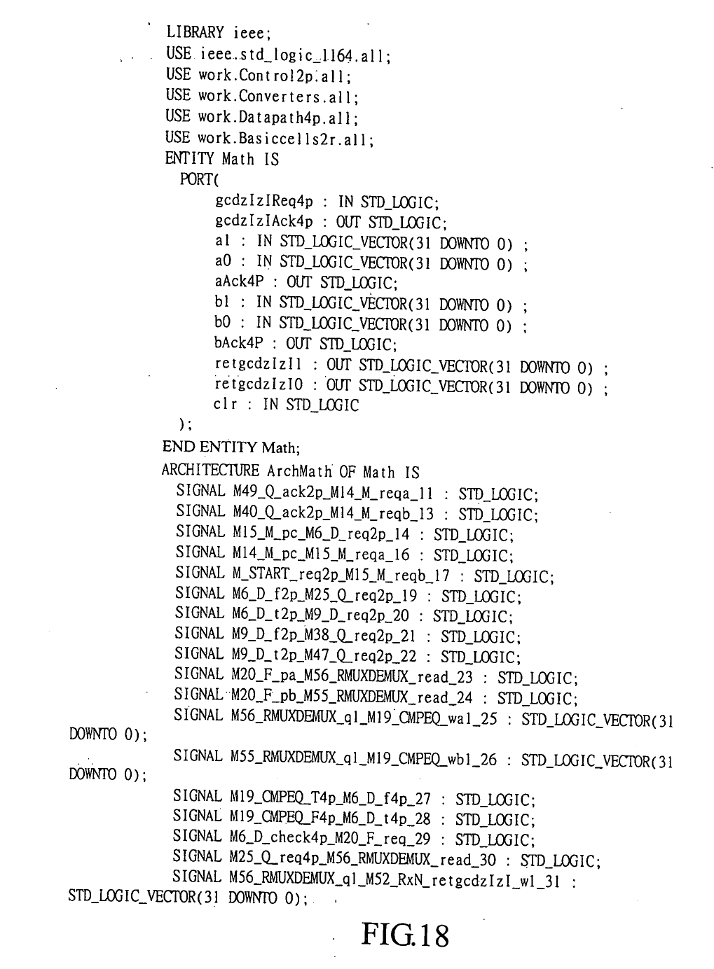

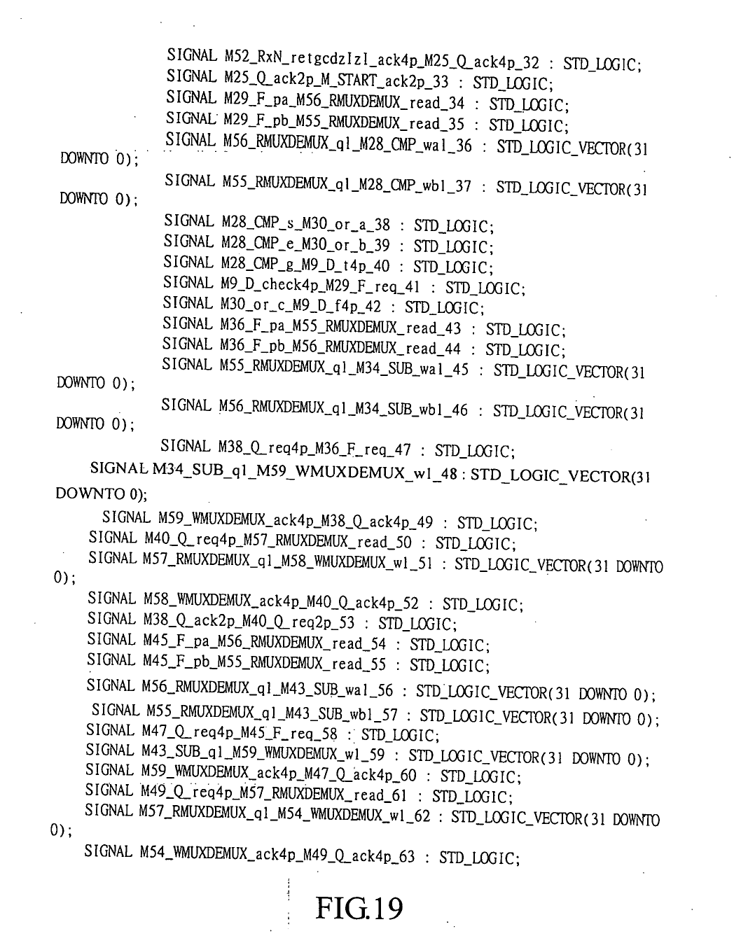

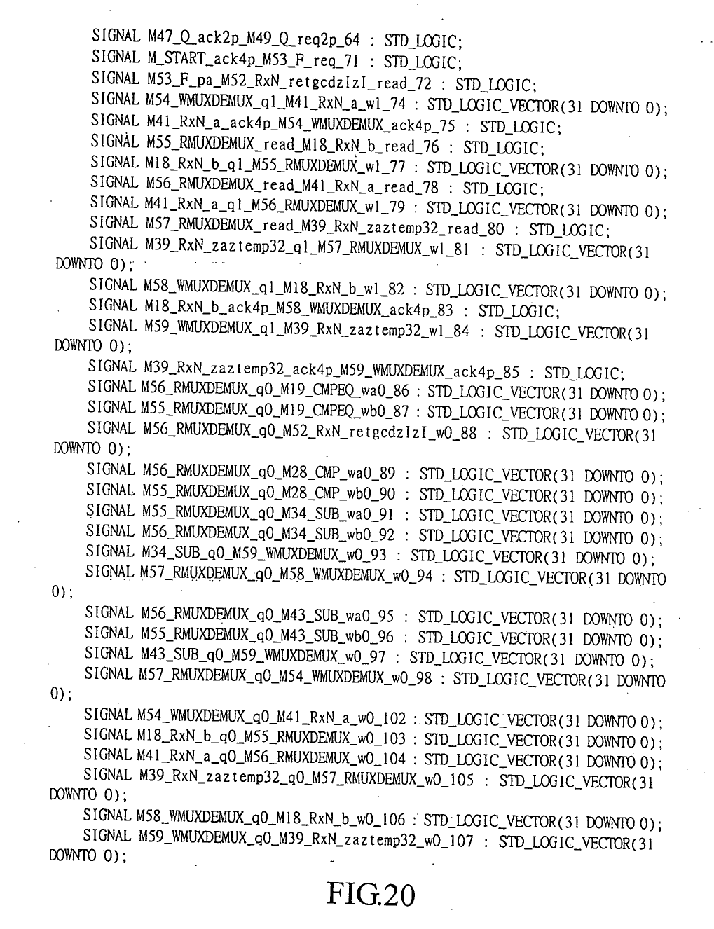

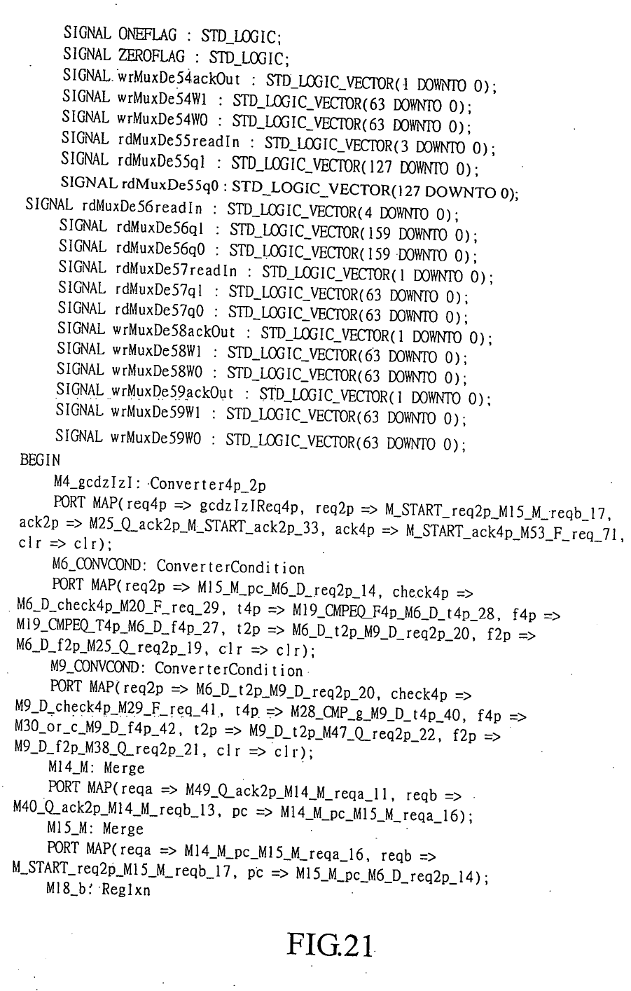

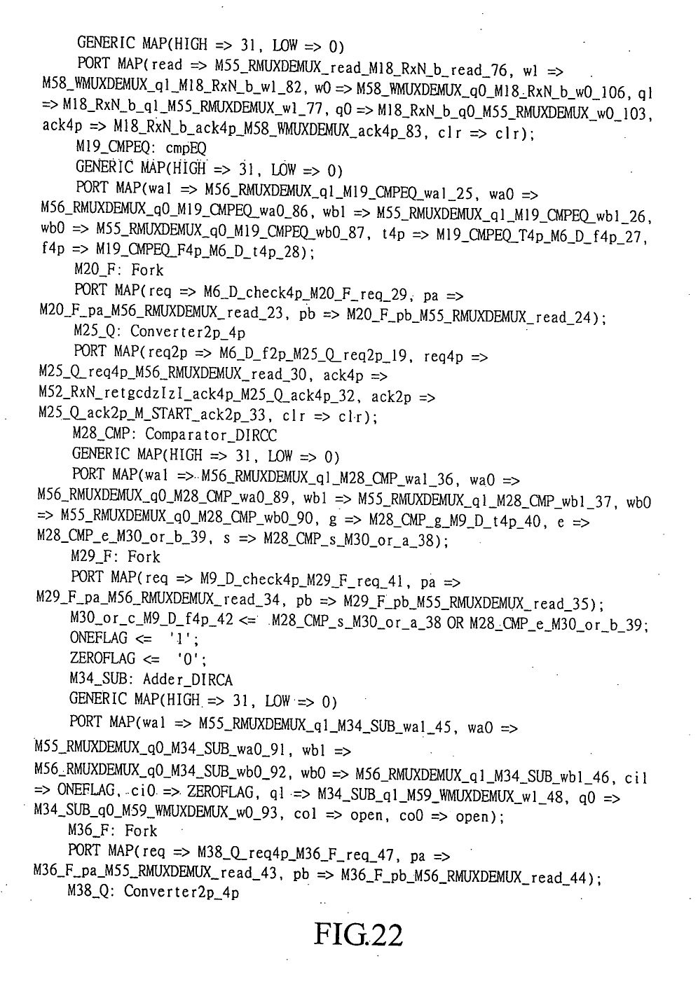

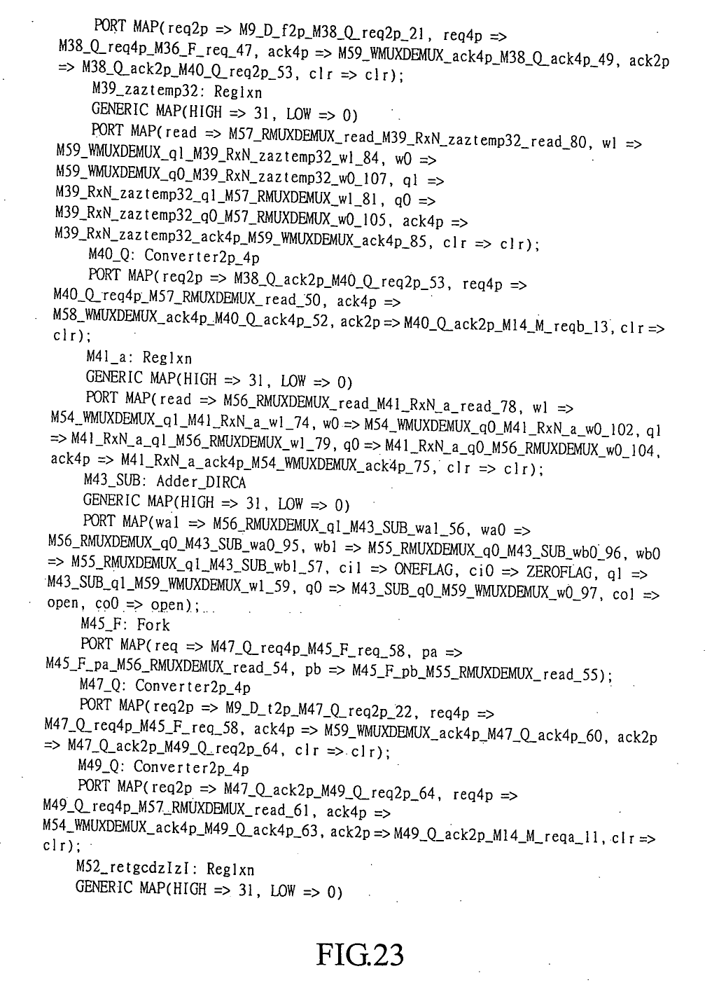

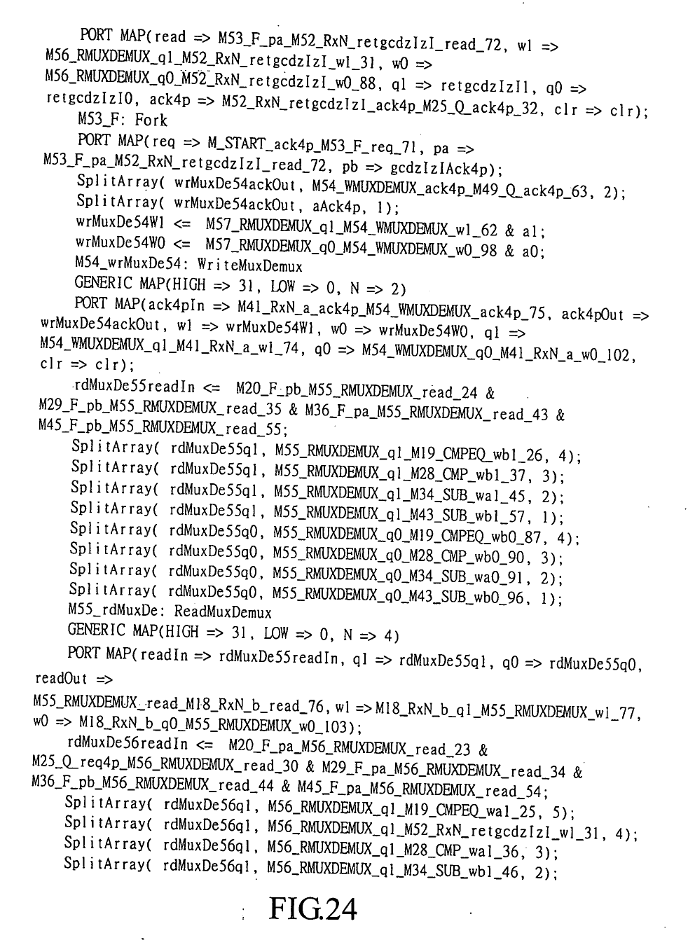

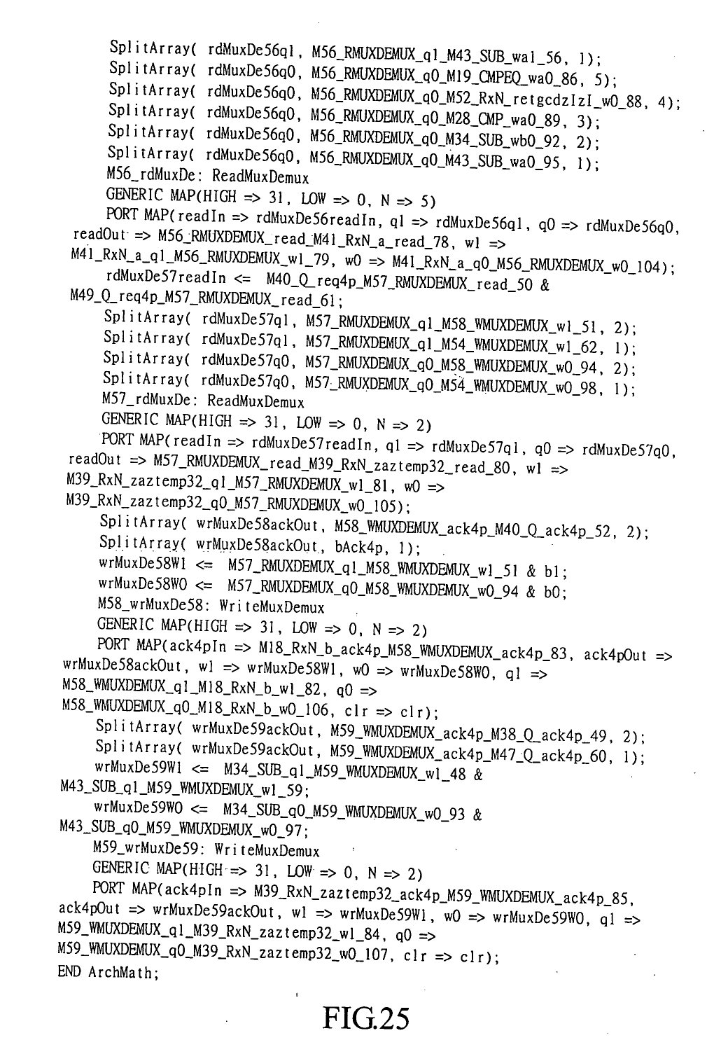

FIGS. 18 to 25 are the VHDL codes obtained by translating the HCG of FIG. 9. In FIGS. 18 to 25, an entity name directs to a method start node, and the edges of the method start nodes are translated into input/output ports of the entity.

Step 1009 determines a type for each node of the HCG to thereby generate corresponding VHDL objects and write associated information in a VHDL architecture. The VHDL objects are generated by a component instantiation.

Step S1011 generates corresponding signal connections of the VHDL components according to the edges of the modified HCG. Step S 1013 outputs the entity and architecture to a file in a string form shown in FIG. 18 to 25. Thus, the modified HCG can match to the VHDL components in a one-to-one manner, such that the VHDL codes can be translated and obtained easily. Accordingly, the problem that an HCG cannot be translated into accurate VHDL codes is avoided.

Thus, at the end of the third stage, a complete HCG is translated into a corresponding HDL.

As cited, the invention applies a three-stage translation mechanism to directly translate the functions described by a high level programming language, such as Java, C, C++, into a VHDL, which is not limited by the type of the high level programming language and can unify into a complete executing flow, without leading to a trouble on the hardware component design.

Although the present invention has been explained in relation to its preferred embodiment, it is to be understood that many other possible modifications and variations can be made without departing from the spirit and scope of the invention as hereinafter claimed.

What is claimed is:

1. A process of automatically translating a high level programming language into a hardware description language (HDL), comprising the steps:
(A) reading source codes coded by the high level programming language;
(B) translating the source codes into an extended activity diagram (EAD);
(C) translating the EAD into a hardware component graph (HCG);
(D) translating the HCG into the HDL; and
(E) outputting the HDL.

2. The process as claimed in claim 1, wherein the high level programming language is Java, C or C++.

3. The process as claimed in claim 1, wherein the EAD is a flow control graph.

4. The process as claimed in claim 1, wherein the EAD comprises start node, end node, curve point node, micro-operation node, fork node, join node, select node and merge node.

5. The process as claimed in claim 1, wherein the HCG indicates a connection relation between hardware components.

6. The process as claimed in claim 1, wherein the HCG comprises three types of start node, end node and component node.

7. The process as claimed in claim 1, wherein the HDL is a VHDL or Verilog.

8. The process as claimed in claim 1, wherein step (B) further comprises the steps:
(B1) reading a source code of the high level programming language;
(B2) translating the source code read in step (B1) into a corresponding subgraph when the source code is not a statement instruction, and executing step (B1);
(B3) translating a statement into a corresponding subgraph when the source code read in step (B1) is the statement instruction and the statement is in front of a condition expression in the statement instruction;
(B4) generating a select node;
(B5) generating left and right curve points respectively linked to the select node;
(B6) translating a statement, which is not in front of the condition expression in the statement instruction, into a corresponding subgraph;
(B7) generating a merge node to merge the subgraphs;
(B8) linking up the subgraph generated in step F with the right curve point;
(B9) linking up the subgraph generated in step F with the merge node; and
(B10) determining if a next source code of the high level programming language is to be translated into a corresponding subgraph; if yes, executing step (A1); and if not, completing and outputting the EAD.

9. The process as claimed in claim 8, wherein the statement instruction comprises five instructions, for, while, do, if and switch.

10. The process as claimed in claim 1, wherein step (C) further comprises the steps:
(C1) reading a subgraph of the EAD, and executing step (C5) when all subgraphs of the EAD is read;
(C2) directly translating the subgraph of the EAD into a corresponding HCG when the subgraph of the EAD is determined to be a fork, join or merge type, and executing (C1);
(C3) performing a syntax analysis and translation on the subgraph of the EAD when the subgraph of the EAD is determined to be a micro-operation type to thus obtain the corresponding HCG, and executing (C1);
(C4) performing a label analysis first and then a syntax analysis and translation on output ports of obtained corresponding HCGs when the subgraph of the EAD is determined to be a select type, translating the subgraph of the EAD determined to be the select type into the corresponding HCG, and executing step (C1); and
(C5) linking all participant input and output ports between the corresponding HCGs to output the HCG.

11. The process as claimed in claim 1, wherein step (D) further comprises the steps:
(D1) reading the HCG, wherein the HCG read has multiple hardware component subgraphs;
(D2) finding a start node of the HCG to thereby obtain a corresponding hardware component subgraph;
(D3) analyzing all information of the start node to thereby add input and output components and generate an HDL entity, and repeating the analyzing until all start nodes are complete;
(D4) determining types on all nodes of the HCG to thereby generate corresponding HDL objects and write associated information in an HDL architecture;
(D5) generating corresponding signal connections of HDL components according to all edges of the HCG; and
(D6) outputting the HDL entity and architecture to a file in a string form.

12. The process as claimed in claim 11, wherein step (D4) applies a component instantiation to generate the corresponding HDL objects.

13. The process as claimed in claim 11, wherein step (D1) further comprises a step of translating the HCG into a modified HCG for translating into the HDL.
